(19) United States
(12) Patent Application Publication
(10) Pub. No.: US 2020/0033129 A1
(43) Pub. Date: Jan. 30, 2020

(54) METHOD FOR SOLVING ATTITUDE OF RIGID BODY BASED ON FUNCTION ITERATIVE INTEGRATION

(71) Applicant: SHANGHAI JIAO TONG UNIVERSITY, Shanghai (CN)

(72) Inventors: Yuanxin WU, Shanghai (CN); Wenxian YU, Shanghai (CN)

(21) Appl. No.: 16/340,128

(22) PCT Filed: Apr. 28, 2017
(86) PCT No.: PCT/CN2017/082317

§ 371 Date: Apr. 7, 2019

(30) Foreign Application Priority Data
Apr. 21, 2017 (CN) 201710273489.3

(51) Int. Cl. G01C 21/18; G01C 21/16

(52) U.S. Cl. CPC G01C 21/18; G01C 21/165

(57) ABSTRACT

The present disclosure provides a method for solving an attitude of a rigid body based on function iterative integration, including: step 1, fitting a polynomial function of an angular velocity according to a gyroscope measurement value over a time interval; step 2, iteratively calculating a Rodrigues vector by using the fitted polynomial function of the angular velocity and a Rodrigues vector integral equation; and Step 3, and obtaining an attitude change over the time interval in terms of quaternion according to the final iterative result of the Rodrigues vector.

### CROSS-REFERENCE TO RELATED APPLICATIONS

This application is a national stage application of PCT Application No. PCT/CN2017/082317. This application claims priority from PCT Application No. PCT/CN2017/082317, filed Apr. 28, 2017, and CN Application No. 201710273489.3, filed Apr. 21, 2017, the contents of which are incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### TECHNICAL FIELD

The present disclosure relates to technical fields of inertial navigation, robots, etc. and in particular relates to a method for solving an attitude of a rigid body based on function iterative integration.

### BACKGROUND

Calculation or estimation of rigid body motion in a three-dimensional space is a key issue in many technical fields, such as physics, robotics, navigation guidance, machinery, and computer vision, etc. Unlike the translational motions such as velocity and position, attitude cannot be directly measured, and could only be obtained in indirect ways, such as, by using angular velocity integration or vector matching. Attitude calculation based on angular velocity integration is completely autonomous, which does not need external information, and thus it is favorable in many applications (such as when the satellite navigation systems cannot work). However, angular velocity measurements by gyroscopes would inevitably have errors, resulting in unbounded drift in the integrated attitude. In fact, it is generally held that even if the angular velocity measurements are accurate, the attitude cannot be accurately calculated due to the noncommutativity of finite rotations. The noncommutativity of finite rotations means that different sequences of finite rotations will generate different attitudes. Therefore, an approximate method has to be utilized to calculate the attitude.

Mainstream attitude computation methods in the field of inertial navigation usually utilized quaternion to describe the current attitude and applied the rotation vector to describe the attitude increment. In general attitude motions, the relationship between the differential of a rotation vector and the angular velocity is very complicated, and it has to be considerably simplified so as to be used in approximate methods. Mainstream attitude computation methods usually approximately estimate the rotation vector by using a plurality of angular velocity or angular increment measurements that are consecutively collected (also called ‘samples’), so the attitude computation could not be started until the last sample is obtained. It would not be a big problem if the attitude computation is the only one to be concerned; however, it would be quite another story when the attitude is taken as an input to the subsequent steps, such as, in an inertial navigation system, the obtained attitude can be used to calculate velocity and position. In addition, all the mainstream attitude computation methods are designed by using a particular motion, for example, the coning motion, as the basis for optimization; however, it would not be optimal in other motions.

Therefore, a heretofore unaddressed need exists in the art to address the aforementioned deficiencies and inadequacies.

### SUMMARY

In view of the deficiencies in the state of the art, the purpose of the present disclosure is to provide a method for computing a rigid body's attitude based on function iterative integration. The present method is based on the technology of function iterative integration, which adopts the Rodrigues vector to analytically reconstruct the attitude from the angular velocity. The differential equation of the Rodrigues vector is simpler than that of the rotation vector and thus allows the iterative integration of polynomial functions to implement accurate attitude reconstruction.

According to the method for attitude computation of a rigid body based on function iterative integration, the method includes the following steps:

Step 1, to fit a polynomial function of angular velocity according to gyroscope measurements over a time interval;

Step 2, to iteratively calculate the Rodrigues vector by using the fitted polynomial function of angular velocity and the Rodrigues vector integral equation; and

Step 3, to obtain the attitude change over the time interval in terms of quaternion according to the final iterative result of the Rodrigues vector.

Preferably, gyroscope measurements take the form of either angular velocity or angular increment.

Preferably, the Step 1 comprises:

with respect to N angular velocity measurements ωₜ_{ₖ}, k=1, 2, . . . N at time tₖ, the polynomial function of angular velocity is fitted by using a polynomial of order less than N−1; or, the polynomial function of angular velocity could be alternatively fitted by the basis of the Chebyshev polynomial.

Preferably, the Step 1 comprises:

with respect to N angular increment measurements Δθₜ_{ₖ}, k=1, 2 . . . N at time tₖ, the polynomial function of angular velocity is fitted by using a polynomial of order less than N−1; or, the polynomial function of angular velocity could be alternatively fitted by the basis of the Chebyshev polynomial.

Preferably, the Step 2 comprises:

The iterative calculation is performed, by substituting the fitted polynomial function into the Rodrigues vector integral equation, until a convergence condition is satisfied or a predetermined value of maximum times of iteration is reached.

As compared with the state of the art, the present disclosure has the following advantages:

1) a new attitude computation method is proposed, which could be extended to a general rigid body motion; 2) the new attitude computation method will strictly converge to an exact attitude when the angular velocity is accurate; 3) the Rodrigues vector iteratively reconstructed from the angular velocity is in terms of analytic polynomial, and thus all the attitude over the corresponding time interval could be obtained; 4) the design of the new attitude computation method does not rely on the assumption of any special motion.

### BRIEF DESCRIPTION OF THE DRAWINGS

The accompanying drawings illustrate one or more embodiments of the present invention and, together with the written description, serve to explain the principles of the invention. Wherever possible, the same reference numbers are used throughout the drawings to refer to the same or like elements of an embodiment.

Other features, objects, and advantages of the present disclosure will become apparent by reading the following detailed description to the non-limited embodiments with reference to the drawings.

FIG. 1 is a flowchart of the attitude computation method of a rigid body based on function iterative integration according to the present disclosure.

### DETAILED DESCRIPTION

The present invention will now be described more fully hereinafter with reference to the accompanying drawings, in which exemplary embodiments of the present invention are shown. The present invention may, however, be embodied in many different forms and should not be construed as limited to the embodiments set forth herein. Rather, these embodiments are provided so that this disclosure is thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It is appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

It is understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It is understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present invention.

It is understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It are also appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It is further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the FIGURES. It is understood that relative terms are intended to encompass different orientations of the device in addition to the orientation shown in the FIGURES. For example, if the device in one of the FIGURES is turned over, elements described as being on the “lower” side of other elements would then be oriented on the “upper” sides of the other elements. The exemplary term “lower” can, therefore, encompass both an orientation of lower and upper, depending on the particular orientation of the FIGURE. Similarly, if the device in one of the FIGURES is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It is further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated.

As used herein, the terms “comprise” or “comprising,” “include” or “including,” “carry” or “carrying,” “has/have” or “having,” “contain” or “containing,” “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

Embodiments of the invention are illustrated in detail hereinafter with reference to accompanying drawings. It should be understood that specific embodiments described herein are merely intended to explain the invention, but not intended to limit the invention.

The disclosure will now be described in details in connection with the embodiments. The following embodiments are intended for facilitating those skilled in the art to understand the present invention, instead of limiting the present invention in any way. It should be noted that a number of variations and modifications may be made by those skilled in the art without departing from the inventive concept, all of which fall within the scope of protection of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip.

The term module may include memory (shared, dedicated, or group) that stores code executed by the processor. The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

In the present disclosure, computer components may include physical hardware components and virtual software components. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

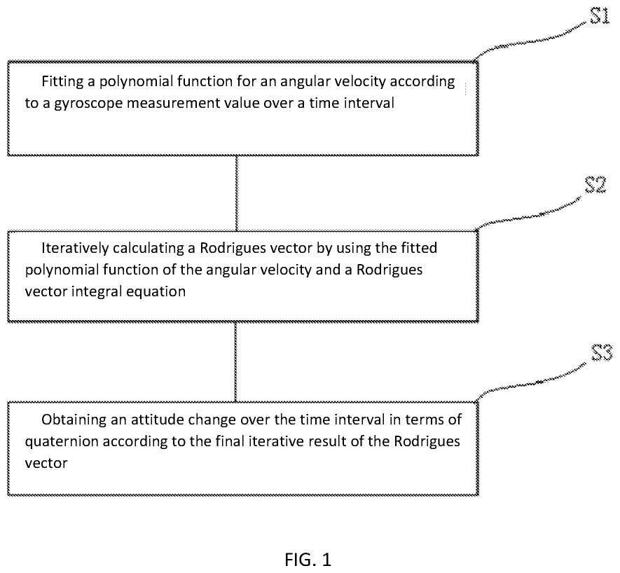

As shown in FIG. 1, the attitude computation method of a rigid body based on function iterative integration according to the present disclosure specifically comprises the following steps:

(1) to fit a polynomial function of angular velocity according to gyroscope measurements over a time interval [0 t];

The gyroscope measurement is generally given by two forms: angular velocity and angular increment, which will be respectively described as follows:

with respect to N angular velocity measurements ωₜ_{ₖ}, k=1, . . . N at time tₖ, the polynomial function of angular velocity is fitted by using a polynomial of order n (less than or equal to N−1), that is,

$$ω = {\sum }_{i = 0}^{n} {c}_{i} {t}^{i} , n \leq N - 1 \qquad ( 1 )$$

where the coefficient cᵢ may be determined by solving the following equation:

$${A}_{ω} [ \begin{matrix}{c}_{0}^{T} \\ {c}_{1}^{T} \\ ⋮ \\ {c}_{n}^{T}\end{matrix} ] • [ \begin{matrix}1 & {t}_{1} & … & {t}_{1}^{n} \\ 1 & {t}_{2} & … & {t}_{2}^{n} \\ ⋮ & ⋮ & ⋮ & ⋮ \\ 1 & {t}_{N} & … & {t}_{N}^{n}\end{matrix} ] [ \begin{matrix}{c}_{0}^{T} \\ {c}_{1}^{T} \\ ⋮ \\ {c}_{n}^{T}\end{matrix} ] = [ \begin{matrix}{ω}_{{t}_{1}}^{T} \\ {ω}_{{t}_{2}}^{T} \\ ⋮ \\ {ω}_{{t}_{N}}^{T}\end{matrix} ] \qquad ( 2 )$$

where [c₀ c₁ . . . cₙ]^{T}=A_{ω}⁻¹[ωₜ_{₁} ωₜ_{₂} . . . ωₜ_{_{N}}]^{T}. When n<N−1, A_{ω}⁻¹ stands for the matrix inverse in the meaning of least squares, A_{ω}⁻¹=(A_{ω}^{T}A_{ω})⁻¹A_{ω}^{T}, and it also applies to the following equation, where T stands for a uniform sampling time interval.

Similarly, with respect to N angular increments Δθₜ_{ₖ}, k=1, 2, . . . N at time tₖ, the polynomial function of angular velocity is fitted by using a polynomial of order n (less than or equal to N−1). The relationship between the angular increments and the angular velocity could be expressed as Δθₜ_{ₖ}, ∫ₜ_{ₖ₋₁}^{t}^{ₖ}ωdt

$${A}_{θ} [ \begin{matrix}{c}_{0}^{T} \\ {c}_{1}^{T} \\ ⋮ \\ {c}_{n}^{T}\end{matrix} ] • [ \begin{matrix}{t}_{1} & \frac{{t}_{1}^{2}}{2} & … & \frac{{t}_{1}^{n + 1}}{n + 1} \\ {t}_{2} - {t}_{1} & \frac{{t}_{2}^{2} - {t}_{1}^{2}}{2} & … & \frac{{t}_{2}^{n + 1} - {t}_{1}^{n + 1}}{n + 1} \\ ⋮ & ⋮ & ⋮ & ⋮ \\ {t}_{N} - {t}_{N - 1} & \frac{{t}_{N}^{2} - {t}_{N - 1}^{2}}{2} & … & \frac{{t}_{N}^{n}}{n + 1}\end{matrix} ] [ \begin{matrix}{c}_{0}^{T} \\ {c}_{1}^{T} \\ ⋮ \\ {c}_{n}^{T}\end{matrix} ] = [ \begin{matrix}{Δθ}_{{t}_{1}}^{T} \\ {Δθ}_{{t}_{2}}^{T} \\ ⋮ \\ {Δθ}_{{t}_{N}}^{T}\end{matrix} ] \qquad ( 3 )$$

That is, [c₀ c₁ . . . cₙ]^{T}=A_{θ}⁻¹[Δθₜ_{₁} Δθₜ_{₂} . . . Δθₜ_{_{N}}]^{T}.

When the order of the fitted polynomial is large, there may be a numerical instability problem in calculating A_{ω}⁻¹ or A_{θ}⁻¹. In order to improve the robustness of calculation, the polynomial function (1) of the angular velocity may also be fitted based on the Chebyshev polynomial;

(2) to iteratively calculate the Rodrigues vector by using the fitted polynomial function of angular velocity and the Rodrigues vector integral equation.

The iterative integral equation of the Rodrigues vector g is expressed as follows:

$${g}_{j + 1} = {\int }_{0}^{t} ( I + \frac{1}{2} {g}_{j} \times + \frac{1}{4} {g}_{j} {g}_{j}^{T} ) ω dt \qquad ( 4 )$$

where the initial value g₀=0. The fitted polynomial function (1) of the angular velocity is substituted into the above formula, and the iterative calculation is performed until a convergence condition is satisfied or a predetermined value of maximum times of iteration is reached.

(3) to obtain the attitude quaternion relative to the start end of the time interval according to the final iterative result of the Rodrigues vector.

$$q = \frac{2 + g}{\sqrt{4 + {\vert g \vert}^{2}}} \qquad ( 1 )$$

The relationship between the length t of the time interval and the number of samples N as well as the uniform sampling time interval T is expressed as t=N×T. For attitude computation on a longer time interval, it could be divided into several small time intervals, and the iterative calculation is performed in turn within each sub-interval.

In principle, the attitude computation method based on function iterative integration according to the present disclosure is also applicable to other three-dimensional attitude parameters (such as the rotation vector), if a certain degree of accuracy loss is acceptable. In such situation, steps 2) and 3) may be adjusted accordingly as follows:

(4) to iteratively calculate the rotation vector by using the fitted polynomial function of angular velocity and the rotation vector integral equation.

The iterative rotation vector integral equation g is expressed as follows:

$${g}_{j + 1} = {\int }_{0}^{t} ( I + \frac{1}{2} {g}_{j} \times + \frac{1}{12} {( {g}_{j} \times )}^{2} ) ω dt , \qquad ( 6 )$$

wherein, the initial value g₀=0. The fitted polynomial function (1) of the angular velocity is substituted into the above formula, and the iterative calculation is performed until a convergence condition is satisfied or a predetermined value of maximum times of iteration is reached.

(5) to obtain the attitude quaternion relative to the start end of the time interval according to the final iterative result of the rotation vector.

$$q = cos \frac{\vert g \vert}{2} + \frac{g}{\vert g \vert} sin \frac{\vert g \vert}{2} \qquad ( 7 )$$

The methods of the present disclosure can be implemented on one or more computers. Specifically, a server and any client device can be one or more computers or remote computing devices. The methods and systems disclosed can utilize one or more computers to perform one or more functions in one or more locations. The processing of the disclosed methods and systems can also be performed by software components. The disclosed systems and methods can be described in the general context of computer-executable instructions such as program modules, being executed by one or more computers or devices. For example, the server includes a fitting module configured to fit a polynomial function of angular velocity according to a gyroscope measurement value over a time interval. As another example, the server also includes a calculation module configured to iteratively calculate a Rodrigues vector by using the fitted polynomial function of angular velocity and the Rodrigues vector integral equation. The server can be located in the server in a central location, whereas the client devices (remote computing devices) can be located at respective user's location. These program modules can be stored on the mass storage device of the server and one or more client devices. Each of the operating modules can comprise elements of the programming and the data management software.

The components of the server and/or client device can comprise, but are not limited to, one or more processors or processing units, a system memory, a mass storage device, an operating system, a system memory, an Input/Output interface, a display device, a display interface, a network adaptor, and a system bus that couples various system components. The server and one or more client devices can be implemented over a wired or wireless network connection at physically separate locations. By way of example, a remote client device can be a personal computer, portable computer, smartphone, a network computer, a peer device, or other common network node, and so on. Logical connections between the server and one or more client devices can be made via a network, such as a local area network (LAN) and/or a general wide area network (WAN).

Specific embodiments of the present disclosure are described as above. The method of the present disclosure can be implemented with the hardware, and/or integrated with the hardware and software together. It is understood that the present disclosure is not limited to the above specific embodiments, and those skilled in the art may make various of modification and changes within the scope of the appended claims, which will not impact the essential contents of the present disclosure. The embodiments and the features thereof in the present disclosure may be combined in any way.

1. A method for solving an attitude of a rigid body based on function iterative integration, comprising the following steps, executed by a processor,
Step 1, fitting a polynomial function of angular velocity according to a gyroscope measurement value over a time interval;
Step 2, iteratively calculating a Rodrigues vector by using the fitted polynomial function of angular velocity and the Rodrigues vector integral equation; and
Step 3, obtaining an attitude change over the time interval in terms of quaternion according to the final iterative result of the Rodrigues vector.

2. The method for solving an attitude of a rigid body based on function iterative integration according to claim 1, wherein the gyroscope measurement value take the form of either angular velocity or an angular increment.

3. The method for solving an attitude of a rigid body based on function iterative integration according to claim 1, wherein the Step 1 comprises:
with respect to N angular velocity measurement values ωₜ_{ₖ}, k=1, 2 . . . N at time tₖ, fitting the polynomial function of the angular velocity by using a polynomial of order less than N−1; or, fitting the polynomial function of the angular velocity according to Chebyshev polynomial.

4. The method for solving an attitude of a rigid body based on function iterative integration according to claim 1, wherein the Step 1 comprises:
with respect to N angular increment values Δθₜ_{ₖ}, k=1, 2 . . . N at time tₖ, fitting the polynomial function of the angular velocity by using a polynomial of order less than N−1; or, fitting the polynomial function of the angular velocity according to Chebyshev polynomial.

5. The method for solving an attitude of a rigid body based on function iterative integration according to claim 1, wherein the Step 2 comprises:
performing the iterative calculation, by substituting the fitted polynomial function of the angular velocity into the Rodrigues vector integral equation, until a convergence condition is satisfied or a predetermined value of maximum times of iteration is reached.

6. The method for solving an attitude of a rigid body based on function iterative integration according to claim 2, wherein the Step 1 comprises:
with respect to N angular velocity measurement values ωₜ_{ₖ}, k=1, 2, . . . N at time tₖ, fitting the polynomial function of the angular velocity by using a polynomial of order less than N−1; or, fitting the polynomial function of the angular velocity according to Chebyshev polynomial.

7. The method for solving an attitude of a rigid body based on function iterative integration according to claim 2, wherein the Step 1 comprises:
with respect to N angular increment values Δθₜ_{ₖ}, k=1, 2 . . . N at time tₖ, fitting the polynomial function of the angular velocity by using a polynomial of order less than N−1; or, fitting the polynomial function of the angular velocity according to Chebyshev polynomial.

8. The method for solving an attitude of a rigid body based on function iterative integration according to claim 6, wherein the Step 2 comprises:
performing the iterative calculation, by substituting the fitted polynomial function of the angular velocity into the Rodrigues vector integral equation, until a convergence condition is satisfied or a predetermined value of maximum times of iteration is reached.

9. The method for solving an attitude of a rigid body based on function iterative integration according to claim 7, wherein the Step 2 comprises:
performing the iterative calculation, by substituting the fitted polynomial function of the angular velocity into the Rodrigues vector integral equation, until a convergence condition is satisfied or a predetermined value of maximum times of iteration is reached.
